(19) United States
(12) Patent Application Publication
(10) Pub. No.: US 2007/0205535 A1
(43) Pub. Date: Sep. 6, 2007

(54) Method of injection molding an article of footwear with a flashing circuit capsule in the heel thereof

(76) Inventor: Pardo Vitulli, Riviere-des-Prairies (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/365,920

(22) Filed: Mar. 2, 2006

(51) Int. Cl. B29C 45/14

(52) U.S. Cl. 264/250; 264/272.15

(57) ABSTRACT

A method of injection molding an article of footwear having a sole and an upper with the sole having a ball section and heel section, the heel section having a circuit capsule encapsulated therein. The circuit capsule is provided with LEDs to generate light beams through the heel of the article of footwear. The method comprises injection molding the sole with a peripheral upwardly extending side wall and then positioning an upper support mold with a sock upper at a predetermined position relative to the sole molded on a female mold. A hot liquid molding material is injected in a vamp forming cavity formed between the female mold and the upper support mold as well as in a capsule sealing cavity formed between a bottom wall of the upper support mold and the heel section of the sole whereby to interconnect the sole and the upper and simultaneously seal the circuit capsule in a capsule locating cavity within the heel portion of the sole.

### TECHNICAL FIELD

The present invention relates to a method of injection molding an article of footwear having a sole and an upper and wherein a flashing circuit capsule is disposed in a capsule locating cavity formed in an inner surface of a heel section of the sole and sealed therein simultaneously with the injection of a hot liquid molding material interconnecting a sock upper to the sole.

### BACKGROUND ART

It is well known in the art to fabricate articles of footwear incorporating in the sole thereof, and particularly in its heel section, a circuit module having LED lamps and which LED lamps are actuated upon displacement of the article of footwear such as when a person wearing the article of footwear is walking. The circuit module is provided with a spring actuated switch which is actuated upon displacement of the article of footwear such as when walking or running and this causes the LED lamps to flash. The sole portion or at least the heel portion of the article of footwear is formed of a translucent plastic material in which the lamps are disposed for the transmission of light.

Reference is made to U.S. Pat. Nos. 4,814,661 and 6,789,913 as examples only of the many patents that exist incorporating such light circuits in the sole of articles of footwear. U.S. Pat. No. 6,132,663 relates to a method of molding a footwear sole component incorporating therein an insert which is secured in the sole of an article of footwear by pouring an encasing material into a hollow area of a first mid-sole portion and around the insert. A hand-operated mold is formed in sections which are closed around the hollow area and the encasing material is cured around the insert in order to secure the insert. Plugs are also used in these methods whereby an insert can be retained in position and an example of such manufacturing is described in U.S. Pat. No. 4,814,661. Spring-actuated switch circuits are also well known in the art and an example thereof is also described in U.S. Pat. No. 6,776,498.

In U.S. Pat. No. 6,132,663, referred to herein-above, the method comprises molding a mid-sole for the article of footwear which is provided with an insert, preferably in the form of a fluid-filled bladder, and apertures, commonly referred to as windows, are provided in the sides of the mid-sole whereby the insert is visible exteriorly of the article of footwear. Articles of footwear often have a mid-sole which is formed of two or more components and the mid-soles are usually formed in molds which require complex shapes in order to form a desired profile. The formation of a mid-sole having multiple components historically has required two separate molds, each having a complex shape matching the entire mid-sole, leading to increased manufacturing complexity and costs. Each half-shoe size has typically required a different set of molds as well leading to increased costs. It is an object of U.S. Pat. No. 6,132,663 to overcome such high labour and expensive molding techniques. Articles of footwear formed with inserts are also typically made of a particular foam material which is formed in a shaped mold and apertures are then cut through the side walls of the sole whereby to place an insert in the aperture and a second material such as polyurethane is poured into the cavity of the insert and left to be cured. This is also a time-consuming and labour-intensive operation.

### SUMMARY OF INVENTION

It is a feature of the present invention to provide a method of injection molding an article of footwear having a sole and an upper with a capsule disposed in a cavity of the sole with the capsule being sealed by injecting a hot liquid molding material over the capsule and simultaneously interconnecting the sole and upper together in a vamp formed between the sole and the upper by the molding material in a single injection step.

Another feature of the present invention is to provide a method of injection molding an article of footwear having a sole and an upper with the sole having a circuit capsule which is encapsulated in the heel portion and wherein the circuit capsule is formed by a solid casting of clear plastic material having the circuit casted therein and wherein the capsule is capable of maintaining its solid state at a temperature exceeding the maximum temperature of the hot liquid molding material used to encapsulate the capsule within the heel.

Another feature of the present invention is to provide a method of injection molding an article of footwear having a sole and an upper and wherein the sole and the upper are interconnected together along a vamp cavity in the molds which communicates with a capsule sealing cavity of the molds and wherein the vamp and capsule sealing cavities are injected hot liquid molding material simultaneously in a single injection molding step to provide a finished article of footwear.

According to the above features, from a broad aspect, the present invention provides a method of injection molding an article of footwear having a sole and an upper with the sole having a heel section. A circuit capsule is encapsulated in the heel section with lights disposed to generate light beams which are visible through at least an exterior portion of the heel section. The method comprises injection molding the sole on a female mold with a capsule locating cavity formed at a predetermined location in the heel section. The capsule locating cavity has an open end in an exterior surface of the sole formed on the female mold. The sole has a peripheral upwardly extending side wall. The female mold is displaced to a capsule loading position and a circuit capsule is located in the cavity. An upper support mold having an upper support section and a sole contacting lower section having a bottom capsule sealing cavity wall in a bottom surface thereof is provided. A sock upper is positioned in close contact over the upper support section. The upper support mold with the sock upper is positioned at a predetermined position above the female mold with the sole contacting lower section in contact with the peripheral upwardly extending side wall of the sole and the bottom capsule sealing cavity wall spaced above the heel section to form a capsule sealing cavity to seal the circuit capsule in the capsule locating cavity. Ring molds and the female mold are positioned in compact relationship to form at least a vamp forming cavity. A hot liquid molding material is then injected in the at least a vamp forming cavity and the capsule sealing cavity simultaneously whereby to interconnect the sole and the sock upper and seal the circuit capsule in the capsule locating cavity.

### BRIEF DESCRIPTION OF DRAWINGS

A preferred embodiment of the present invention will now be described with reference to the accompanying drawings in which:

FIG. 1 is a perspective view showing a water-proof boot formed with the method of the present invention and wherein a light emitting diode circuit is encapsulated within the heel of the boot to generate light through the translucent material of at least the heel section of the boot;

FIG. 2A is a perspective view showing a casted rectangular circuit capsule having its components completely sealed in a rectangular molded capsule of translucent material;

FIG. 2B is a section view through the circuit capsule;

FIG. 2C is a section view showing the spring switch located in a housing which is encapsulated within the circuit capsule;

FIG. 3A is a side view of the sole forming female mold;

FIG. 3B is a side view of the male sole forming mold;

FIG. 3C is a side view of the female mold of FIG. 3A with a sole molded in a sole molding cavity thereof;

FIG. 4 is a top view of the female mold showing the sole molded in the cavity thereof;

FIG. 5 is a simplified side schematic view showing the construction of a Ferris-wheel molding mechanism containing three upper support molds interconnected together and their relationship to the ring molds and the female mold containing the sole injected thereon;

FIG. 6 is a simplified schematic top view showing two female molds secured to a positioning mechanism;

FIG. 7 is a simplified top view showing the ring molds in a closed position and the injection nozzle positioned at the parting line of the molds;

FIG. 8 is a fragmented view showing the capsule sealed in the heel cavity by the molding material which communicates between the last cavity and the capsule sealing cavity under the upper support mold;

FIG. 9 is a cross-section view showing the molded heel section of the sole with a capsule locating cavity and the capsule prior to being inserted within the cavity; and

FIG. 10 is a section view showing the relationship of the molded sole with respect to the sock upper and the sealing cavity wall of the upper support mold when the ring molds and female mold are brought into closed position prior to injection and illustrating the disposition of the sock with respect to the peripheral side wall of the sole and the capsule sealing cavity with respect to the vamp cavity.

### DESCRIPTION OF PREFERRED EMBODIMENTS

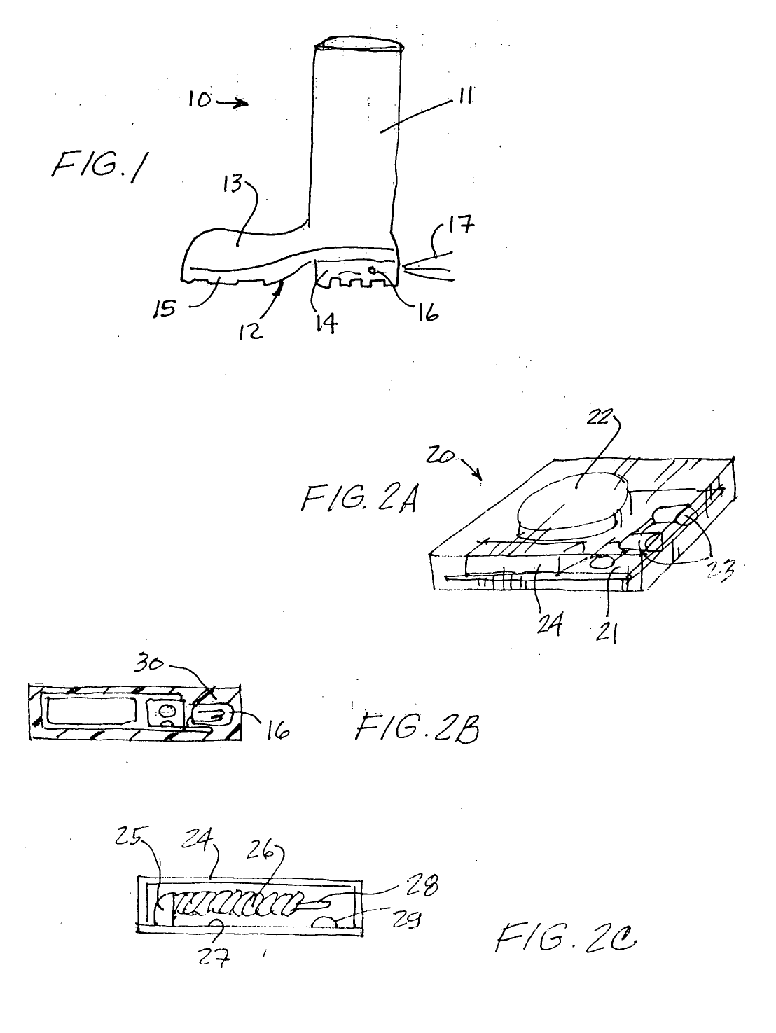

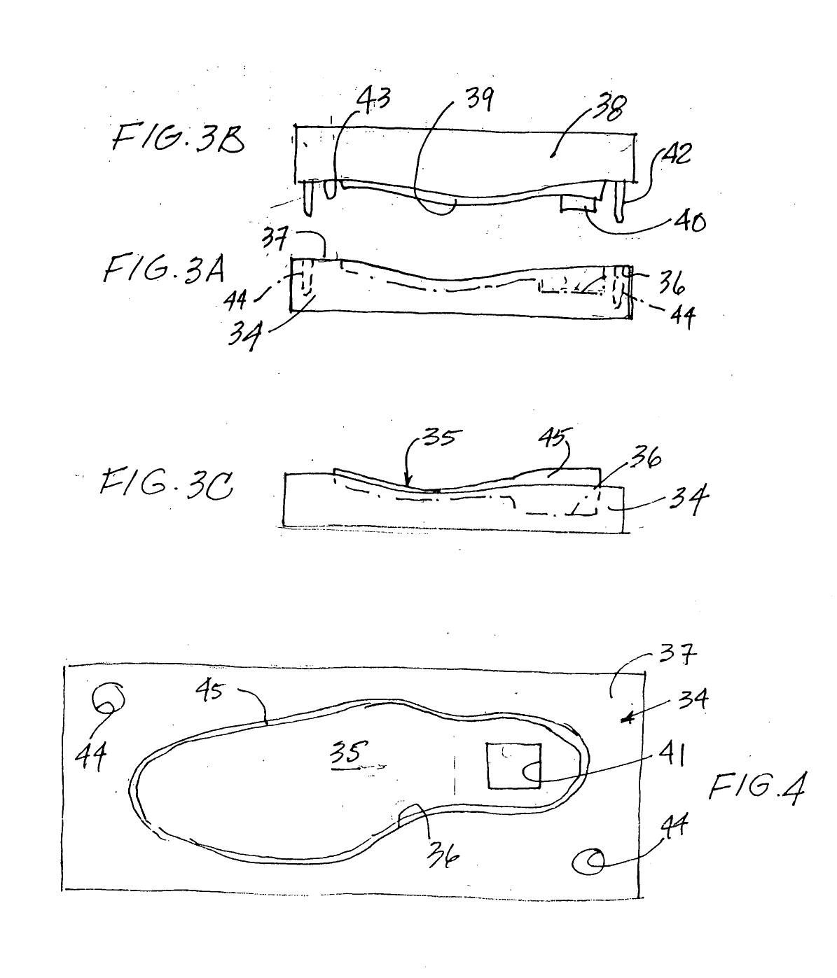

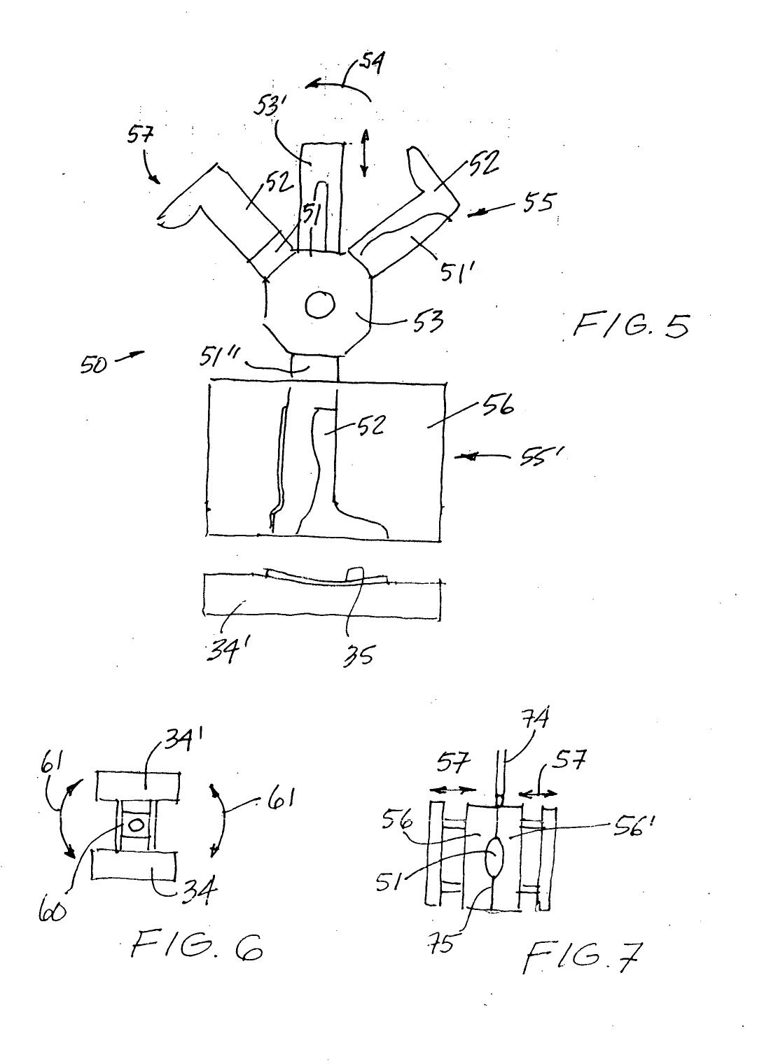

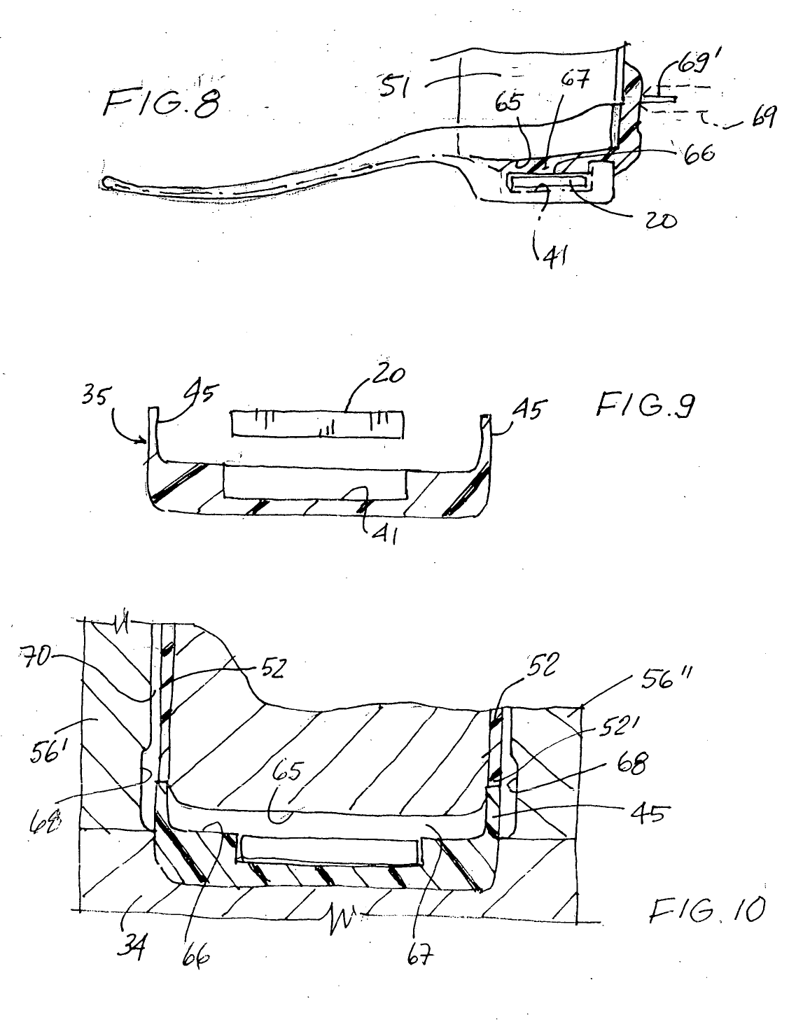

Referring now to the drawings and more particularly to FIG. 1, there is shown generally at 10 an article of footwear comprising an upper 11 and a sole 12 having a ball section 13 and a heel section 14. An injection molded vamp 15 interconnects the upper 11 to the sole 12, as will be described later. The heel 14 is injection molded with a translucent PVC material whereby light emitting diodes (LEDs) 16, when generating light beams 17, are visible through the heel 14.

As shown in FIGS. 2A to 2C, a circuit capsule 20 is comprised of a circuit board 21 on which is mounted a battery 22 to feed current to light emitting diodes 23 through a vibration actuated switch located in a housing 24. The vibration actuated switch is illustrated in FIG. 2C and it comprises a contact 25 to which is secured a helical conducting spring 26 spaced above a bottom wall 27 of the housing 24. The spring has a contact end 28 which is positioned spaced above a contact element 29 which connects to the LEDs. The LEDs connect back to the battery whereby to complete the conducting circuit. When the spring 26 is placed into vibration the contact end 28 will touch the contact element 29 and close the circuit whereby to cause the light emitting diodes 16 to light and produce light beams which are visible through the translucent heel 14 of the article of footwear, such as shown at 10 in FIG. 1. The circuit components are encapsulated into a clear plastic material 30 capable of maintaining its solid state at a temperature of at least 180° C. whereby when subjected to hot liquid molding material, which is at a slightly lower temperature, will not deform to affect the circuit components molded therein. The housing 24 provides for the displacement of the vibration contact with the encapsulated material molded about the housing.

With reference now to FIGS. 3A to 4, there is shown the construction of the molds for forming the sole 35. The sole 35 is injection molded into the molding cavity 36 formed in the upper surface 37 of the female mold 34, as illustrated in FIG. 4. As best seen in FIG. 3A, the female mold 34 co-acts with a male mold 38 which is brought in contact therewith by well known mold interconnecting parts. The male mold 38 is provided with a sole forming dye 39 having a projecting plug 40 which is configured to form a capsule locating cavity 41 in the heel section 14 of the sole 35. Of course, the plug 40 has a shape to form a cavity 41 shaped to receive the configuration of the capsule 20 which could be square, circular, etc. Positioning pins 42 project from the mating surface 43 of the male mold for precise location with relation to the female mold 34 and in registry with pin locating holes 44 provided in the upper surface 37 thereof. The male and female molds are brought together and a hot liquid molding material is injected within a sole cavity formed between the molds 34 and 38 whereby to form the sole 35 as illustrated in FIG. 4.

As shown in FIG. 3C, the injection cavity for the sole 35 is so configured that the sole is molded with a peripheral upwardly extending side wall 45 thereabout.

As shown in FIG. 5, the method of injection molding the article of footwear 10 as shown in FIG. 1 comprises an upper support mold assembly 50. The assembly comprises at least one, herein three upper support molds 51 which are configured whereby to receive a sock upper 52 in close fit thereover. This sock upper 52 is shown fragmented in one of the upper support molds, herein mold 51. This sock upper 52 can be printed with a pattern, colored or clear or a combination. The upper support molds 51 are interconnected together on a mold displacing Ferris-wheel mechanism 53 which is rotated by suitable drive means, not shown but obvious to a person skilled in the art. These upper support molds are rotated in the direction of arrow 54 by a timing mechanism and stopped for a predetermined period of time at each of the three positions as shown in FIG. 5. As hereinshown the upper support mold 51′ is positioned at a sock loading and footwear removal station 55 where the sock upper 52 is positioned about the mold 51′ and wherein the finished product as shown in FIG. 1 is removed from the mold 51′ when it is returned to the position 55 after leaving the ring molds 56 where the final product is injection molded. After a sock upper 52 is loaded on the upper support mold 51′ and the article of footwear 11 has left the ring mold 56, it is displaced to a standby position 57 while the previous sock upper is molded to the sole 35 positioned within the molding cavity 36 of the female mold 34.

As shown in FIG. 6, there are two female molds 34 and 34′ which are secured to a positioning mechanism 60 whereby the molds 34 and 34′ are displaced in the direction of arrows 61, 180 degrees from one another with the mold 34′ positioned at a precise location under the upper support mold 51″.

As shown in FIGS. 5 and 7, the ring molds 56 are herein comprised of two mold sections 56′ and 56″ which are moved to and away from each other in the direction of arrows 57. When the ring molds 56′ and 56″ are open, the Ferris-wheel mechanism 53 is lowered on its guide support 53′ whereby to position the upper support mold 51″ therebetween. The ring molds 56′ and 56″ are then brought in contact with one another along a parting line 75, as shown in FIG. 7, with the upper support mold 51″ therebetween. These ring molds define upper last forming cavities and vamp cavities whereby an upper last and a vamp can be molded to interconnect the sock upper 52 to the sole 35 and particularly the peripheral side wall 45 of the sole 35, as clearly illustrated in FIGS. 8 and 10 which will be described later. Once the ring molds are closed, the mechanism 60 is displaced to position the female mold 34′ in registry with the ring molds and the injection nozzle 74 is brought into position for injecting the hot molding material which can be PVC or TPR. Simultaneously, the female mold 34 and the male mold 38 are closed whereby a sole is injection molded at the same time as the vamp cavity and upper last cavity together with the capsule sealing cavity, and such will now be described with reference to FIGS. 8 to 10.

As shown in FIGS. 8 and 10, the upper support mold 51 has a bottom capsule sealing cavity wall 65 which is spaced above the heel section upper wall 66 whereby to form a capsule sealing cavity 67 therebetween as better illustrated in FIG. 10. The ring molds 56′ and 56″ are further provided with a vamp cavity 68 in a lower portion thereof and bridging the lower end 52′ of the sock upper 52 with the peripheral flange 45 of the sole 35. However, before the ring molds are closed the encapsulated circuit module 20 is positioned within the capsule locating cavity 41, as shown in FIG. 9. This can be done manually or in an automated manner.

As better shown in FIG. 8, the vamp cavity 68 is in communication with the bottom capsule sealing cavity 67. Once the molds are closed, an injection nozzle 74 as hereinshown by phantom line 69 injects a hot liquid molding material therein with the material flowing throughout the capsule sealing cavity 67, the vamp cavity 68 and the upper last cavity 70 all about the sock upper. The hot liquid molding material can be any suitable material such as PVC and it is heated to a temperature of from about 120° C. to 180° C. Accordingly, the circuit capsule 20 must be molded of a material capable of sustaining such maximum high temperature. After the molds separate the injection nipple is cut off.

It is pointed out that when the article of footwear 10 has been molded about the upper support mold at the molding station 55′, the upper support mold mechanism is displaced upwardly and the article of footwear 10 is removed from the mold 51′ at the station 55. Another sock upper 52 is then placed over this upper support mold 51′ while another article of footwear is molded at the molding station 55′.

The hot melt molding material is a clear colour pigmented material or could simply be a translucent clear material without color pigment but the color provides an aesthetic appearance to the article of footwear while permitting the transmission of the light beams through the heel of the article of footwear. As herein illustrated, the article of footwear is a rain boot but it is within the ambit of the present invention to cover any other article of footwear wherein the upper may have a variety of shapes as well as the sole, but as herein described and illustrated the upper and sole are interconnected together and the capsule is sealed within the heel in a single molding step.

It is within the ambit of the present invention to cover any other obvious modifications provided such modifications fall within the ambit of the appended claims.

I claim:

1. A method of injection molding an article of footwear having a sole and an upper, said sole having a heel section, a circuit capsule, encapsulated in said heel section with lights disposed to generate light beams which are visible through at least an exterior portion of said heel section, said method comprising the steps:
i) injection molding said sole on a female mold with a capsule locating cavity formed at a predetermined location in said heel section, said cavity having an open end in an exterior surface of said sole formed on said female mold, said sole having a peripheral upwardly extending side wall,
ii) displacing said female mold to a capsule loading position,
iii) placing said circuit capsule in said capsule locating cavity,
iv) providing an upper support mold having an upper support section and a sole contacting lower section having a bottom capsule sealing cavity wall in a bottom surface thereof,
v) positioning a sock upper in close contact over said upper support section,
vi) positioning said upper support mold with said sock upper at a predetermined position above said female mold with said sole contacting lower section in contact with said peripheral upwardly extending side wall of said sole and said bottom capsule sealing cavity wall spaced above said heel section to form a capsule sealing cavity to seal said circuit capsule in said capsule locating cavity,
vii) positioning ring molds and said female mold in closely spaced relationship to form at least a vamp forming cavity,
viii) injecting a hot liquid molding material in said at least a vamp forming cavity and said capsule sealing cavity simultaneously whereby to interconnect said sole and said sock upper and seal said circuit capsule in said capsule locating cavity.

2. A method of injection molding an article of footwear as claimed in claim 1 wherein said step (vii) comprises forming a vamp cavity all about said sock with said vamp forming cavity integral therewith.

3. A method of injection molding an article of footwear as claimed in claim 2 wherein said step (viii) comprises injecting a hot liquid PVC material at a temperature of from about 120° C. to 180° C.

4. A method of injection molding an article of footwear as claimed in claim 3 wherein said circuit capsule comprises a circuit board, a battery, one or more light emitting diodes and a vibration actuated switch; said switch being mounted in a housing to permit actuation thereof, said circuit capsule being formed by casting a clear plastic material over and about said components to form a rectangular circuit capsule, said clear plastic material being selected from a material capable of maintaining its solid state at a temperature of at least 180° C.

5. A method of injection molding an article of footwear as claimed in claim 1 wherein there is further provided two of said female molds secured to a positioning mechanism whereby to:
a) position one of said female molds at an injection position under a male mold, said male mold having a cavity forming plug depending from a dye heel section thereof,
b) displace said male mold on top of said female mold to form a sole injection cavity therebetween, and effecting said step (i), and simultaneously with step (a) effecting the step of:
c) positioning the other of said female molds with said sole molded thereon at an upper support mold matting position where said ring molds are retracted.

6. A method of injection molding an article of footwear as claimed in claim 5 wherein said step (vii) comprises the steps of (d) lowering said upper support mold with said sock upper between said retracted ring molds, (e) closing said ring molds about said upper support mold to form a vamp cavity all about said sock, and displacing said other of said female mold with said sole molded thereon for registry with said ring molds and effecting step (viii).

7. A method of injection molding an article of footwear as claimed in claim 1 wherein said step (iv) comprises providing at least two of said upper support molds interconnected together on a mold displacing Ferris-wheel mechanism, said step (v) comprising (f) positioning said sock on one of said at least two of said upper support molds at a sock loading and footwear removal station, the other of said at least two of said upper support molds having been positioned as in step (vi).

8. A method of injection molding an article of footwear as claimed in claim 7 wherein after step (f) there is provided the step of (g) displacing said mold displacing Ferris-wheel mechanism to position said other of said at least two of said upper support molds as in step (vi).

9. A method of injection molding an article of footwear as claimed in claim 7 wherein there are three of said upper support molds interconnected together and spaced apart 120° C. apart from one another.

10. A method of injection molding an article of footwear as claimed in claim 7 wherein simultaneously with said step (viii) there is provided the step of (h) removing said article of footwear molded on said one upper support mold and placing said sock upper on said one upper support mold.

11. A method of injection molding an article of footwear as claimed in claim 10 wherein prior to step (h) there is provided the steps of (i) opening said ring molds and (j) withdrawing said Ferris-wheel mechanism.

12. A method of injection molding an article of footwear as claimed in claim 11 wherein after said step (j) there is provided step (c) and effecting step (iii).

13. A method of injection molding an article of footwear as claimed in claim 12 wherein said step (h) and step (iii) are effected by manual operations.

14. A method of injection molding an article of footwear as claimed in claim 1 wherein said method comprises injection molding a rain boot article of footwear.
